(19) United States
(12) Patent Application Publication
(10) Pub. No.: US 2004/0030013 A1
(43) Pub. Date: Feb. 12, 2004

(54) Novel rheology modified hydrophobic compositions, modification agents, and methods of making

(76) Inventor: Edgar Franklin Hoy, Kingwood, TX (US)

Correspondence Address: Barbara J Tribble, 112 Pansy Path, Lake Jackson, TX, 77566, US

(21) Appl. No.: 10/433,530

(22) PCT Filed: Feb. 28, 2002
(86) PCT No.: PCT/US02/06576

(30) Foreign Application Priority Data
Feb. 28, 2001 (US) 09/795,735

(51) Int. Cl. C08L 1/00

(52) U.S. Cl. 524/174

(57) ABSTRACT

The present invention relates to rheology modification agents for use in hydrophobic based fluids, wherein the agents comprise a hydrophobic layered hydroxide material.

### TECHNICAL FIELD

This invention relates to the field of rheology modification agents for use in oil or other hydrophobic based fluids, and more particularly the method of making these rheologically modified fluids and agents useful for preparing such compositions.

### BACKGROUND ART

The use of rheology modification agents, frequently thickening agents, for oil and hydrophobic (organophilic) fluids and more particularly low viscosity/low aromatic oils has been common practice in a large number of industries. These fluids include, for example, oil field drilling fluids, metal-working fluids, mining fluids, ag-organic formulations, hydraulic fluids, oil-based paints and coating fluids, stripping fluids, and the like. For each of these, and other, applications, the rheology modification agents serve very specific purposes tailored to the function for which the fluid is being employed. Among these purposes are lubricity, suspension of solids; adjustment of reaction time(s); protection against temperature extremes or variations; durability and resistance to degradation under conditions of use; protection from undesirable external forces such as bacterial attack, oxidation, or chemical reaction such as corrosion; and the like. Because a variety of properties are frequently needed for a given fluid, the rheology modification agent has frequently been used in conjunction with other types of agents or additives, in order to produce a final fluid suitable to a given application. However, since it is generally desirable to reduce the number of such agents or additives as much as possible, in order to facilitate the ease of production and use and therefore to also minimize cost, it is desirable to employ a rheology modification agent which offers the greatest number of benefits to the fluid for its intended use.

A variety of general rheology modification agents are known and have been qualified for use in various specific applications. For example organic-based materials such as organophilic lignite, asphaltines, fatty acids which have been dimerized or trimerized, and alkanolamines or amides have historically been used as rheology modification agents in oil-based drilling fluids, but have been found to be unstable in the presence of various salts encountered in some formations and in subsea drillsites. These materials also tend to exhibit undesirable susceptibility to oxidation and bacterial attack; to degradation when exposed to the shear forces exerted in the drilling process; and/or to thermal degradation above about 250 to 300° F. They also have limited ability to maintain solids suspension upon elimination of shear forces such as those produced during pumping.

Showing both better thermal stability and solids suspension are some of the non-organic-based materials, typically organophilically treated clays such as bentonite and attapulgite. For example, organophilic bentonite is relatively stable to temperatre and offers the additional benefits of resistance oxidation and durability when exposed to high shear conditions. These organophilically treated mineral clays are often used with other types of agents or densifiers, such as iron oxide or barium sulfite, which enhance the ability of the fluid to resist pressures such as are encountered in subterranean excavations.

Unfortunately, the organophilically treated mineral clays, though historically popular, are not without their drawbacks for many applications. Fluids containing organophilically treated bentonite usually require a high level of water-based agent to activate them, thus causing an invert emulsion to form, i.e., the water is on the inside and the oil is on the outside (oil wet). The most popular of the organophilic clay materials for drilling muds, are severely compromised in the presence of aqueous-phase polyvalent cations, such as calcium and magnesium, frequently present in drilling formations, and also require high clay concentrations (up to 25 weight %) which may become so thick at higher temperatures under some circumstances that thinners must frequently be added. Other clay systems, and may not be adequately consistent in composition from batch to batch.

Combinations of organophilically treated clays and organic-based materials have also been employed, with the goal of extending the clay and thereby using less of it as disclosed in U.S. Pat. No. 4,816,551. Thus, the complexity of the composition is increased and therefore its cost and/or difficulty of preparation, particularly under field conditions. Typical extenders useful with organophilically treated bentonite systems include amide resins. Unfortunately, the weaknesses of the extending organic-based material, such as thermal or aqueous-phase instability, excess foam and the like, may then dominate the characteristics of the fluid as a whole. In many cases they still suffer from some of the problems associated with the organic-based, clay and combination agents, such as limited inhibition of reactivity with some cations, undesirable toxicity, temperature limitations and a high level of usage of clay and more particularly when trying to modifiy low viscosity/low aromatic oils. In particular, many of these agents are extremely expensive and thus impractical for drilling-scale applications in particular.

It would therefore be highly useful in the field to identify a family of agents which impart rheology modification to oil systems, and more particularly low viscosity/low aromatic oils, such that their viscosity levels, with or without application of shear forces, can be optimized at each point in time according to the desired application; which exhibit desirable temperature resistance, lubricity, inhibition of reactivity, and resistance to geological formation pressure; aqueous phase intrusion and which are not cost-prohibitive for large scale application.

### DISCLOSURE OF INVENTION

The present invention provides such a family of agents and rheology modified oil-based compositions. It includes a rheology-modified oil based composition comprising an organophilic layered double hydroxide material whose constituents substantially conform to the proportions of Formula I

M′ₘM″ₙ(OH)_{(2m+3n+qa+br)}(A^{q})ₐ(B^{r})_{b}:

where M′ represents at least one divalent metal cation and m is an amount of from than zero to about 4; where M″ represents at least one trivalent metal cation and n is an amount of from greater than zero to about 3; where A is an anion or negative-valence radical that is monovalent or polyvalent, and a is an amount of A ions of valence q, provided that if A is monovalent, a is from greater than zero to about 6, and if A is polyvalent, a is from greater than zero to about 3; where B is a second anion or negative-valence radical that is monovalent or polyvalent, and where b is an amount of B ions of valence r and b is from zero to about 1: provided qa+br cannot be greater than 2m+3n; where (2m+3n+qa+br) is greater than zero; and a hydrophobic fluid. Such hydrophobic fluid is preferably a low viscosity/low aromatic oil. The composition can optionally further comprise an organophilic clay and a water activating agent.

The present invention further includes a method of making a rheology-modified oil-based composition comprising admixing an organophilic layered double hydroxide material as defined hereinabove with such hydrophobic fluid and, optionally, an organophilic clay and a water activating agent. A method of preparing this composition by admixing the constituents as separate components, or generating the formula compound in situ in the hydrophobic fluid, is also encompassed. The invention also includes a dry composition useful for rheology modification of hydrophobic fluids comprising an organophilic layered double hydroxide and, optionally, an organophilic clay, and a method of making such composition.

Finally, the present invention still further includesa rheology modified composition useful for subterranean excavation comprising an organophilic layered double hydroxide material as defined by the formula, a water activating agent and, optionally, an organophilic clay, an organophilic aluminum salt, or both, and a method of making such composition.

In the present invention the compositions including the hydrophobic fluid exhibit improved low shear rheology and maximized yield, as defined hereinbelow, which makes them particularly, though not solely, suitable for use as a drilling fluid, milling fluid, or mining fluid. These compositions preferably also exhibit desirable solids suspension capability, desirable inhibition, as shown by incidence of corrosivity and other reactions; low toxicity, and excellent thermal stability; when compared with other known rheology modification agents. They are also generally not prohibitively expensive for large scale applications.

MODES FOR CARRYING OUT THE INVENTION

The present invention provides a novel family of compositions which can be classified generally as rheology modified agents which are useful in hydrophobic fluids, including but not limited to oil and oil-based fluids of many types, and the fluids themselves as modified by the agents. It is noteworthy that the rheology modification, improved low shear rheology and increased yield attainable via practice of this invention cannot be explained as a result of known physical chemistry interactions, i.e., none of the individual components which make up the composition can, by itself, produce the found level of oil-based fluid rheology modification. Furthermore, the degree of viscosity increase is clearly a result of synergy, since no one of the individual components comprised in the rheology modification agents can itself produce the viscosity level attained by their combination, and the level attained is greater than the sum of the components' effects.

A particular advantage of the present invention is that it is efficacious even at relatively high temperatures preferably more than 200° F., more preferably more than 300° F., and most preferably more than 400° F.). It is particularly useful that the compositions also exhibit improved low shear rheology and increased yield gel strength as well.

This ability to “gel” rapidly, using the term “gel” colloquially and without reference to the precise nature of the chemical and/or ionic bonding and/or composition of the material, is particularly important in applications such as drilling and mining, where solids suspension is critical in maintaining the integrity of the excavation during work stoppages and where pumpability must be easily reinitiated in order to ensure restarts. Those skilled in the art will understand that the term “drilling” is used herein in its broadest meaning, to include not only the field of exploitation of geological deposits such as petroleum and/or natural gas, but also any technical accessory drilling, including but not limited to tunneling, so-called “river crossing”, the sealing of dump sites, water well drilling, construction applications such as horizontal directional drilling in general, and the like.

A key starting material for the present invention is an organophilic layered double hydroxide material which conforms substantially to the chemical formula

M′ₘM″ₙ(OH)_{(2m+3n+qa+br)}(A^{q})ₐ(B^{r})_{b}·xH₂O,

as defined hereinabove. This material may be encountered as a single compound or combination of compounds, or can be generated in situ in the selected hydrophobic fluid. While M′ can represent any divalent metal cation of the Groups IIA, VIIB, VIII, IB or IIB of the Periodic Table, preferred divalent cations are Mg, Ca, Mn, Fe, Co, Ni, Cu, and Zn, and more preferred are Mg and Ca. M′ is a trivalent metal cation selected from Groups IIIA or VIII, but preferred are Al, Ga and Fe, and more preferred is Al.

There must also be present at least one anion or negative-valence radical, A, and in some cases one (or more) additional anions or negative-valence radicals, B, may also be present. Examples of these anions and negative-valence radicals include carbonate, amines, stearates, chlorides, oxides, and the like. Preferred are carbonates, oxides and stearates.

Layered double hydroxides are defined herein and in the art in general as synthetic or natural lamellar hydroxides with two kinds of metallic ions in the main layers and interlayer domains containing anionic species. A. De Roy describes them in detail in his article entitled “Lamellar Double Hydroxides”, published in Volume 2, Synthesis of Microporous Structures, Chapter 7 (Van Nostrand Reinhold NY, 1992), which is incorporated herein by reference in its entirety.

In selecting this first required material or combination of materials, such that the proportions of constituents substantially conform to the given chemical formula (Formula I), it will be seen that it is particularly convenient to select an hydrotalcite or “hydrotalcite-like” compound which has been surface-treated such that it has become organophilic and, therefore, hydrophobic. For purposes of this application “hydrophobic” is defined most broadly as referring to a material or system which is entirely non-aqueous in its constituency and which is not miscible with water to any appreciable extent, while “organophilic” is defined as a subset of “hydrophobic” and refers to materials or systems that are specifically miscible with oils (hydrocarbons produced at the wellhead or refined petroleum or synthetically made, all in liquid form) or which are capable of indefinite dispersion therein. Hydrotalcite itself has the chemical formula Mg₆Al₂(CO₃)(OH)₁₆·4(H₂O), and “hydrotalcite-like” compounds are defined as those having the same basic constituents (Mg, Al, CO₃ and OH), but in different proportions (still within the chemical formula required for this invention) and with a variable amount, or no, bound water. Such can include certain natural and synthetic minerals or, as already noted, may be generated in situ via addition to the hydrophobic fluid of any material or materials which ultimately contribute the constituents in the given formula proportions. An example of a hydrotalcite-like material which is both hydrophobic and has been surface-treated such that it has become organophilic is sold by Alcoa Corporation under the tradename “HTC-S”.

It is important to note that the preparation of the formula-based material designated as component “(1)” in the present invention is frequently determinative of its degree of hydrophobicity. It is desirable in the present invention to ensure that the material has a low partition coeficient, when compared with a water-octanol mixture as described in the “water-octanol partition coefficient test”. The test consists of the following: The fluid in question is place in a 50-50 weight percent mixture of water and octanol. This mixture is stirred, then the two resulting layers separated and analyzed for the quantity of organic material in each phase. The amount of organic in the water layer is divided by the amount of organic in the octanol. This dimensionless fraction is known as the “partition coefficient” and is at least about 0.95, preferably 0.95 to 0.99, i.e., the amount of organic in the octanol layer should be relatively very high. This level of hydrophobicity is important in ensuring that this formula-defined constituents, of either the rheology modification agents or of the (hydrophobic) rheology modified compositions, are completely compatible with the hydrophobic fluid. It has been found that preparing component (1) in a hydrophobic environment, which may further be organophilic, helps to ensure such compatibility, while preparation in an aqueous environment appears to substantially reduce or even destroy the effectiveness due to resulting lower partition coefficient. One method of preparation includes employing an additive, along with the formula-defined constituents, with organophilic functionality, such as a vinylsilane and/or N-methylpyrollidone. In this case it is hypothesized that the additive, which may be used as a surface treatment or combined as a solution or dispersion, associates with the formula-defined constituents in some way which enhances the ability of the constituents to then further interact with the organophilic clay and, ultimately, with the hydrophobic/organophilic fluid which is being rheology-modified.

In preparing the dry rheology modification agents of the present invention it is preferable in one embodiment to combine the material or materials, whose constituents substantially conform to the chemical formula, with a clay which has been treated sufficiently to make it organophilic. One method of treatment is to contact the clay with a quaternary amine or other organophilic surfactant, which can be sprayed onto the surface or used as an impregnant. Such a clay represents one category of so-called “beneficiated” clays which are available commercially. The clay is preferably a smectitic clay of any type, with preferred clays including bentonite, chlorite, polygorskite, saconite, vermiculite, halloysite, sepiolite, illite, kaolinite, attapulgite, montmorillonite, Fuller's earth, mixtures thereof, and the like. The selected organophilic clay can be combined via mixing with the defined material or materials to form a dry composition which is particularly suitable for shipping and storage. However, it is also possible to use the rheology modification agent in a hydrophobic fluid without the presence of clay, and thus, in such an embodiment, the agent would not be combined in dry form or at any other point with any clay but, rather, shipped and added to the hydrophobic fluid neat or with other appropriate additives according to the final fluid properties desired.

It is preferred that the final rheology modified composition have a temperature resistance based upon a desired application, i.e., have a given temperature stability, which is defined as the range of temperature within which the desired phase transformations, defined as stress-dependent fluidity, are not disrupted and undesired degradation of the composition as a whole does not occur. A particular advantage of the present invention is that the rheology modification agent can be used without clay, i.e., simply the agent and a very small amount of water activating agent (which may be simply water itself). The rheology modification and stress-dependent fluidity effects are seen even without clay, and since it is the decomposition of clay that limits the upper temperature range for most conventional “muds”, the temperature range can be raised simply by elimination of the clay. With the present invention it is possible to achieve a temperature stability of up to at least about 300° F., more preferably at least about 400° F., and most preferably at least about 450° F.

An important optional component, not to be included in dry (shippable) modification agents but efficacious in fluid compositions such as the rheology modified compositions of the present invention when clay is included therein, is defined herein as a “dispersal agent”. The purpose of the dispersal agent is to further enhance the dispersion of the organophilic clay component in the rheology modified composition. It is important to note that increasing the dispersion of the clay can be used as a means to decrease the total amount of clay needed to obtain a given level of viscosity increase. Clay disperses best when its layers can be separated, and to accomplish this water and other polar solvents are particularly efficacious. Among these are organic materials including alcohols (for example, methanol, ethanol and polyols) and also alkyl carbonates (such as propylene and ethylene carbonate). For reasons of cost and ease of use, water is preferred. Interestingly, the presence of water as a dispersal agent in the rheology modified compositions of the present invention does not appear to compromise either the essentially hydrophobic nature of the compositions themselves or their applicability for use in hydrophobic systems including oil or oil-based systems.

Additional components may also be added, to either the dry composition or to the rheology modified fluid composition. Such additional components most preferably include at least an organophilic aluminum salt. These additional components preferably serve to increase the temperature resistance of the final rheology modified hydrophobic composition, which is particularly desirable for applications such as drilling, milling and mining. It is preferred that the final rheology modified composition have a temperature resistance based upon a desired application, but those skilled in the art will be able to balance the amount of these additional additives to achieve a given temperature stability, which is defined as the range of temperature within which the desired maximum viscosity and shear-thinning capability are not undesirably disrupted and undesired degradation of the composition as a whole does not occur. With appropriate amounts of one or both of these additives, it is possible to achieve a temperature stability of these compositions of up to at least about 325° F., more preferably to about 375° F., and most preferably to about 425° F.

It is preferred that, if an organophilic aluminum salt is added, it is selected from crystalline forms, such as aluminum oxalate or aluminum stearate. The aluminum salt is preferably present in an amount of from at least about 0.05 weight percent, more preferably from about 2.0 weight percent, most preferably from about 3 weight percent, to about 10 weight percent, more preferably to about 5 weight percent, based on weight of the dry formulation.

Other additives which may be useful in rheology modified compositions of the present invention include weighting agents, such as calcium carbonate, barium sulfate, and/or magnetite (Fe₃O₄); gas hydrate modifiers, such as glycol and glycerine; corrosion inhibition agents, such as quaternary halides, especially bromides; and the like. Another advantage of the present invention is that it has an inherently low dynamic fluid loss potential and exhibits inherently good lubricity, thus making additives to achieve these properties unnecessary in many embodiments.

Water plays an important part in the present invention where clay is used. Where use of an organophilic clay has been selected, a significant amount of water is necessary to form the rheology modified compositions of the present invention. The water, which may be water itself acts to swell the clay and also as an activating agent to promote the rheology modification effects of the formula-defined material/hydrophobic fluid combination. If clay is not to be included, however, addition of water is not necessary, except where the desire is to generate the Formula I material in situ, in the hydrophobic fluid. Thus, in that instance water serves simply to solubilize the alkoxides to supply M′ and M″, as well as contributing to the hydroxyl anion. Deionized or distilled water are strongly preferred, to limit the occurrence of undesirable side reactions. The amount of water in embodiments where clay is used is preferably very low, less than 5 percent, more preferably less than 2 percent, based on the weight of the total composition. Its order in mixing is not critical but in some cases may somewhat affect the desired efficiency of the rheology modification. It is thus possible to combine, in dry form, the formula-defined material or materials with the clay and, optionally, additional agents tailored to provide the desired range of properties of the final composition, and then add the resultant dry composition to the hydrophobic fluid with the water, or to add either the formula-defined material or the clay to the water first and then add the other constituents to the hydrophobic fluid in any order thereafter. It may be desirable in some cases to limit time of exposure of the dry composition, and/or of any dry components thereof, to air due to the inherently hygroscopic nature of some of the components, for example, the hydrotalcite and hydrotalcite-like materials. Optimization of mixing via any known mechanical means, including for example use of impeller devices, rotational mixing, or other inducement of turbulence, is desirable to ensure consistency in performance.

Regardless of mixing order, the proportions of the components of the rheology modified compositions are most conveniently calculated based upon their ratios and upon their weight percentage in the hydrophobic fluid composition as a whole. If clay is included, it is preferably from about 0.2 to 15, more preferably from about 0.5 to 10, and most preferably from about 1 to 4, percent based on the combined weight of the formula compound (the rheology modification agent), the clay, and the hydrophobic fluid. Thus, the clay is preferably present in any concentration which increases the viscosity of the hydrophobic fluid.

In partial summary, it will be noted that, because of the variety of mixing options represented hereinabove, it is possible to prepare a fully dry composition, suitable for shipping, storage and/or later hydration; a fluid (liquid) composition, particularly suited to small scale batching; or a fluid (liquid) composition prepared in situ, such as would be encountered when either the fully dry composition or small scale liquid composition is added to a much larger liquid environment, such as that encountered in a drilling rig mud pit. The final result, using any of these compositions, will be a viscosified hydrophobic fluid composition which can be used at a wide variety of temperatures. Of particular importance is the fact that these compositions can be used in drilled wells having temperatures ranging from preferably from about 45° F., more preferably about 70° F., to at least about 450° F. In addition to their thermal stability and predetermined maximum viscosity, which is preferably the “gelled” elastic solid phase, they also preferably exhibit excellent stress-dependent fluidity. In general, the reduction in viscosity upon stress application, also referred to as “shear-thinning”, can be graphically predicted, with the relationship between viscosity (defined in centipoise) being substantially linear when plotted against shear rate (defined as sec⁻¹, which is a log scale). Finally, under conditions of actual use the phase transition from elastic solid to true fluid under shear conditions is rapid, preferably within about 2 minutes, more preferably effectively instantaneous, and the return to the elastic solid, or “gelled” state, occurs preferably within about 10 minutes, more preferably within about 5 minutes, and most preferably within about 0.5 minute. This last quality enables the composition to suspend drill, mill and mining solids particularly well upon cessation of shear forces such as those exerted by drill bits or during pumping. The resultant composition is furthermore preferably durable, exhibiting no or reduced reduction in its ability to make such rapid viscosity transitions upon intermittent and repeated applications of shear and in a wide variety of environments, including cation-rich environments.

These and other properties of the present invention will be further illustrated via the following examples, which are meant to be for illustrative purposes only and not meant to limit, nor should they be construed as limiting, the scope of the invention in any way.

### EXAMPLE 1

About 0.50 g of Alcoa Corporation's “HTC-S” product, described by the manufacturer as a surface-treated, organophilic hydrotalcite, is mixed with a previously prepared dispersion of 8.5 g of an organophilic bentonite clay (“Genie 3PA” from Oil DRI Corporation) in 280 g of a seal mineral oil, which is a low viscosity and low aromatic content oil as defined hereinabove. Mixing is carried out using a Hamilton Beach mixer, on medium speed, for about 2 minutes, and then 3 g of water is added. The resulting composition thickens virtually immediately and shear is continued for about 20 minutes thereafter.

The composition's Theological properties are tested using standard methodology as described in detail in Manual of Drilling Fluids Technology, 1985, NL Baroid/NL Industries Inc., with the following results:

| | |
|---|---|
| Yield Point | 78 lb/100 ft² |
| Plastic Viscosity | 18 centipoise |
| 6 RPM* Reading | 45 Fann Units** |
| 3 RPM Reading | 42 Fann Units |

*RPM means revolutions per minute.
**All shear readings are determined using a Fann 35 Viscometer.

### COMPARATIVE EXAMPLE A

For comparative purposes, a composition is prepared according to Example 1, except that no organophilic hydrotalcite is added to the previously prepared dispersion of organophilic clay in oil. The composition is then tested as in Example 1, with the following results:

| | |
|---|---|
| Yield Point | 18 lb/100 ft² |
| Plastic Viscosity | 11 centipoise |
| 6 RPM | 3 Fann Units |
| 3 RPM Reading | 2 Fann Units |

### EXAMPLE 2

A composition is prepared according to Example 1, except that following its preparation the composition is heated to about 300° F. for about 40 hours. The composition is then allowed to cool to about 80° F. and is then tested as in Example 1, with the following results:

| | |
|---|---|
| Yield Point | 70 lb/100 ft² |
| Plastic Viscosity | 15 centipoise |
| 6 RPM | 32 Fann Units |
| 3 RPM Reading | 30 Fann Units |

### EXAMPLE 3

A composition is prepared according to Example 1, except that following the addition of the surface-treated, organophilic hydrotalcite, about 0.44 g of basic aluminum oxalate, commercially sold as “BOA” by Alcoa, is also added. The composition is then allowed to shear according to Example 1, and then tested with the following results:

| | |
|---|---|
| Yield Point | 77 lb/100 ft² |
| Plastic Viscosity | 17 centipoise |
| 6 RPM Reading | 42 Fann Units |
| 3 RPM Reading | 40 Fann Units |

### EXAMPLE 4

A composition is prepared according to Example 4, and the final composition is then heated to 300° F. for 40 hours. The composition is then allowed to cool to about 80° F. Its rheological properties are then tested as in Example 1 with the following results:

| | |
|---|---|
| Yield Point | 86 lb/100 ft² |
| Plastic | 12 centipoise |
| 6 RPM | 56 Fann Units |
| 3 RPM Reading | 55 Fann Units |

### EXAMPLE 5

About 20 g of a 5 weight percent magnesium alkoxide (e.g., magnesium diethoxide) in hexane solution is added to about 30 g of a 4 weight percent aluminum alkoxide (e.g., aluminum triethoxide) in cyclohexane solution. The combination, about 50 g, is then added to about 280 g of seal mineral oil. Mixing is carried out in a Hamilton Beach mixer. About 1.47 g of water is added as an activating agent. The resulting mixtures thickens virtually immediately.

| | |
|---|---|
| Yield Point | 71 lb/100 ft² |
| Plastic | 7 centipoise |
| 6 RPM | 29 Fann Units |
| 3 RPM Reading | 27 Fann Units |

1. A rheology-modified hydrophobic composition comprising (1) a hydrophobic material whose constituents substantially conform to the proportions of Formula I
M′ₙM″ₙ(OH)_{(2m+3n+qa+br)}(A^{q})ₐ(B^{r})_{b}:
where M′ represents at least one divalent metal cation and m is an amount of from greater than zero to about 4; where M″ represents at least one trivalent metal cation and n is an amount of from greater than zero to about 3; where A is an anion or negative-valence radical that is monovalent or polyvalent, and a is an amount of A ions of valence q, provided that if A is monovalent, a is from greater than zero to about 6, and if A is polyvalent, a is from greater than zero to about 3; where B is a second anion or negative-valence radical that is monovalent or polyvalent, and where b is an amount of B ions of valence r and b is from zero to about 1; provided qa+br cannot be greater than 2m+3n; (2) a hydrophobic fluid; and (3) a water activating agent.

2. The composition of claim 1 wherein M′ is selected from Groups IIA, VIIB, VIII, IB or IIB of the Periodic Table.

3. The composition of claim 2 wherein M′ is selected from Mg, Ca, Mn, Fe, Co, Ni Cu, and Zn, and M″ is selected from Al, Ga and Fe.

4. The composition of claim 1 wherein the hydrophobic fluid is an oil.

5. The composition of claim 1 further comprising an organophilic clay.

6. The composition of claim 5 wherein the clay is selected from bentonite, chlorite, polygorskite, saconite, vermiculite, halloysite, sepiolite, illite, kaolinite, attapulgite, montmorillonite, Fuller's earth, and mixtures thereof, which have been organophilically-treated.

7. The composition of claim 6 further comprising a dispersal agent.

8. The composition of claim 7 wherein the dispersal agent is selected from water, alcohols, polyols, alkyl carbonates and mixtures thereof.

9. The composition of claim 1 further comprising an organophilic aluminum salt.

10. A method of preparing a rheology-modified hydrophobic composition comprising contacting (1) a hydrophobic material whose constituents substantially conform to the proportions of Formula I
M′ₘM″ₙ(OH)_{(2m+3n+qa+br)}(A^{q})ₐ(B^{r})_{b}:
where M′ represents at least one divalent metal cation and m is an amount of from greater than zero to about 4; where M″ represents at least one trivalent metal cation and n is an amount of from greater than zero to about 3; where A is an anion or negative-valence radical that is monovalent or polyvalent, and a is an amount of A ions of valence q, provided that if A is monovalent, a is from greater than zero to about 6, and if A is polyvalent, a is from greater than zero to about 3; where B is a second anion or negative-valence radical that is monovalent or polyvalent, and where b is an amount of B ions of valence r and b is from zero to about 1; provided qa+br cannot be greater than 2m+3n; and (2) a hydrophobic fluid.

11. The method of claim 10 wherein the proportions of the hydrophobic layered double hydroxide of Formula I come from more than one source and are generated in situ.

12. The method of claim 10 wherein an organophilic clay, a dispersal agent, an organophilic aluminum salt, or a combination thereof, is also admixed therewith.

13. A substantially dry rheology modification agent suitable for use in subterranean excavations comprising the hydrophobic layered double hydroxide of Formula I and an organophilic clay, a dispersal agent, an organophilic aluminum salt, or a combination thereof.

14. A method of making the substantially dry rheology modification agent of claim 13 comprising admixing the hydrophobic layered double hydroxide of Formula I with an organophilic clay, a dispersal agent, an organophilic aluminum salt, or a combination thereof.
